(19) United States
(12) Patent Application Publication
(10) Pub. No.: US 2020/0248741 A1
(43) Pub. Date: Aug. 6, 2020

(54) BEARINGS

(71) Applicant: Hewiett-Packard Development Compaany , L.P., Spring, TX (US)

(72) Inventors: Kynan Church, Vancouver, WA (US); Asa Weiss, Vancouver, WA (US)

(73) Assignee: Hewiett-Packard Development Compaany , L.P., Spring, TX (US)

(21) Appl. No.: 16/615,808

(22) PCT Filed: Jul. 10, 2017
(86) PCT No.: PCT/US2017/041416

§ 371 Date: Nov. 21, 2019

(51) Int. Cl. F16C 17/02; B41J 13/076; F16C 13/02; F16C 33/20

(52) U.S. Cl. CPC F16C 17/02; B41J 13/076; F16C 2240/70; F16C 33/20; F16C 13/02

(57) ABSTRACT

A bearing includes a body that defines a first arcuate support surface and a second arcuate support surface. The first and second arcuate support surfaces are to cradle a rotatable circular shaft against a net radial load that is to act on the shaft. The first arcuate support surface has a radius of curvature larger than a radius of the shaft. The second arcuate support surface has a radius of curvature larger than the radius of the shaft. The first and second arcuate support surfaces are positioned on opposite sides of a direction of action of the net radial load.

### BACKGROUND

Rotating shafts may be used in printers and other machines for a variety of purposes. Bearings, such as V-bearings and journal bearings, are often used to support a shaft for rotation. These kinds of bearings often have no moving parts and typically provide a bearing surface that supports the shaft.

### BRIEF DESCRIPTION OF THE DRAWINGS

FIG. 1 is a perspective diagram of an example bearing.

FIG. 2 is a perspective diagram of an example printer.

FIG. 3 is a perspective diagram of another example bearing.

FIG. 4 is a perspective diagram of an example bearing in an example paper-feed operation.

FIG. 5 is an end view of an example bearing.

FIG. 6 is an end view of example surfaces of an example bearing.

FIG. 7 is an end view of example surfaces of another example bearing.

FIG. 8 is an end view of example surfaces of another example bearing, where the example surfaces have unequal radiuses.

### DETAILED DESCRIPTION

Rotation of a shaft may over time wear a rut into a flat planar surface of a V-bearing. This may cause undesirable or unpredictable radial displacement of the shaft. Additional maintenance may be required for a machine, such as a printer, that uses such a bearing. In printers that require accurate positioning of a paper-feed shaft, print quality may degrade over time due to wear of such a bearing.

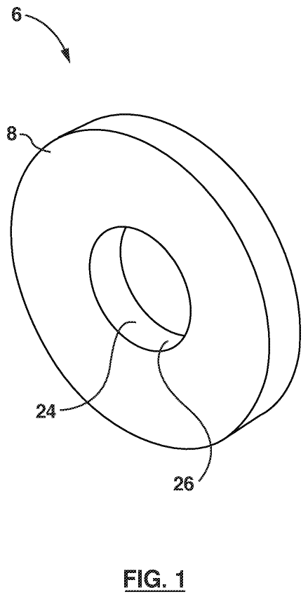

FIG. 1 shows an example bearing 6 that has a body 8 that defines two opposing arcuate support surfaces 24, 26 located on opposite sides of an opening that receives a circular shaft. The body 8 may have any suitable shape and size. The arcuate support surfaces 24, 26 are to support the shaft for rotation. The arcuate support surfaces 24, 26 may each have a radius that is larger than the radius of the shaft to cradle the shaft and support the shaft against a net radial load that acts on the shaft.

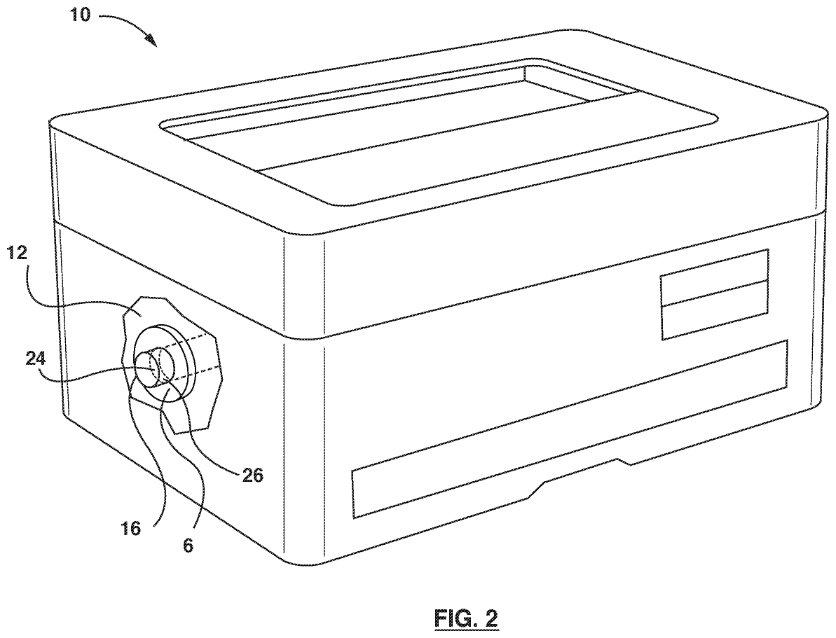

FIG. 2 shows an example printer 10. The printer 10 includes a frame 12, which may be referred to as a body, housing, or chassis. The printer 10 may include other components, not shown, such as a print head, ink/toner supply, paper tray, control circuit, processor, memory, motor, paper-feed mechanism, user interface, and similar.

The printer 10 further includes a bearing 6 fixed to the frame 12 and a shaft 16 that is rotatably supported by the bearing 6. The bearing 6 includes two opposing arcuate support surfaces 24, 26 to support the shaft 16 relative to the frame 12 and allows the shaft 16 to rotate about its longitudinal axis.

The shaft 16 may be a paper-feed shaft to feed paper past a print element, such as an inkjet print head, to have ink printed to the paper. The shaft 16 may be a shaft that drives an ink roller of a laser printer. The shaft 16 may be used for any relevant rotational component of the printer 10. The shaft 16 may drive or be driven by a mechanism, which may include a belt, chain, gear, sprocket, or similar. The printer 10 may include a motor that drives the shaft 16.

The shaft 16 may be circular, at least for a segment of the shaft 16 that mates with the bearing 6. The entire shaft 16 may be circular. The shaft 16 may be made of metal, at least for the segment of the shaft 16 that mates with the bearing 6.

Each arcuate support surface 24, 26 of the bearing 6 may have a radius that is larger than the radius of the shaft 16 to cradle and support the shaft 16 against a net radial load that acts on the shaft 16.

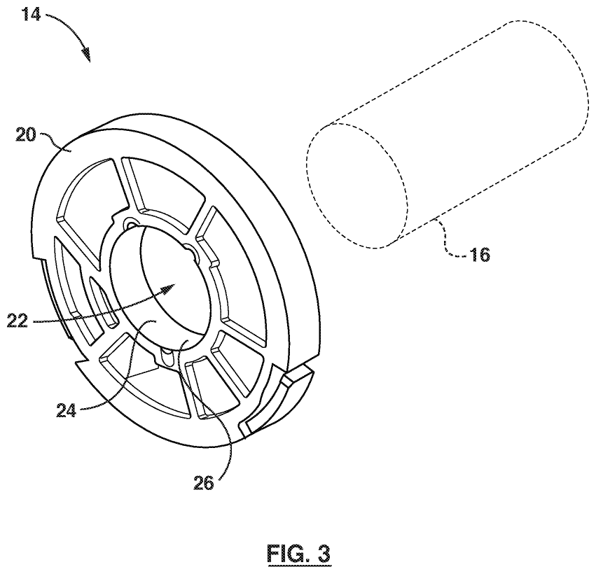

FIG. 3 shows the example bearing 14. The bearing 14 includes a body 20, which may be partially or completely made of plastic. The bearing 14 may be used in the printer 10 or in any other machine that has a rotating shaft.

A shaft opening 22 may be provided in the body 20. The shaft opening 22 may entirely surround the shaft 16 when the shaft 16 is inserted into the opening 22. The shaft opening 22 may serve to capture the shaft 16 and maintain the shaft 16 at a stable radial position as the shaft 16 rotates.

The body 20 has a first arcuate support surface 24 and a second arcuate support surface 26. The support surfaces 24, 26 may have one degree of curvature, in that each surface 24, 26 is curved or arc-shaped in the sense of the circular shape of the shaft 16 and extends linearly in the direction of the length of the shaft 16. A support surface 24, 26 may be defined by a radius of curvature that is larger than a radius of a shaft 16 and that is non-concentric with the center of the shaft 16. The support surfaces 24, 26 partially define the opening 22 and cradle the shaft 16 against gravity and other forces. The support surfaces 24, 26 may be made of plastic.

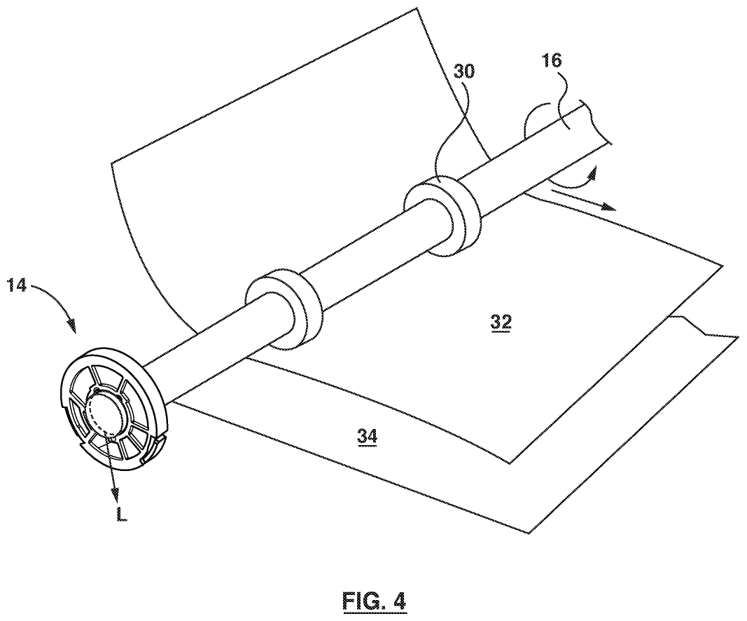

FIG. 4 shows the example bearing 14 in an example of operation. A shaft 16 is captured by the bearing 14 and is driven to rotate. A roller 30 may be provided on the shaft 16 to contact a sheet of paper 32 or other print medium. Friction between the roller 30 and the paper 32 may convert the rotation of the shaft 16 into translation of the paper 32. Support structure 34 may be provided to support the paper 32 against the roller 30.

The shaft 16 may experience a net radial load L that is supported by the bearing 14. The net radial load L may include forces such as gravity, a reaction by the paper 32 being fed by the shaft 6 as supported by any backing structure 34 that supports the paper 32, and similar. The net radial load L may be static, dynamic, or a combination of such, and may change during various operations, The net radial load L may be an expected average load that is determined at time of design.

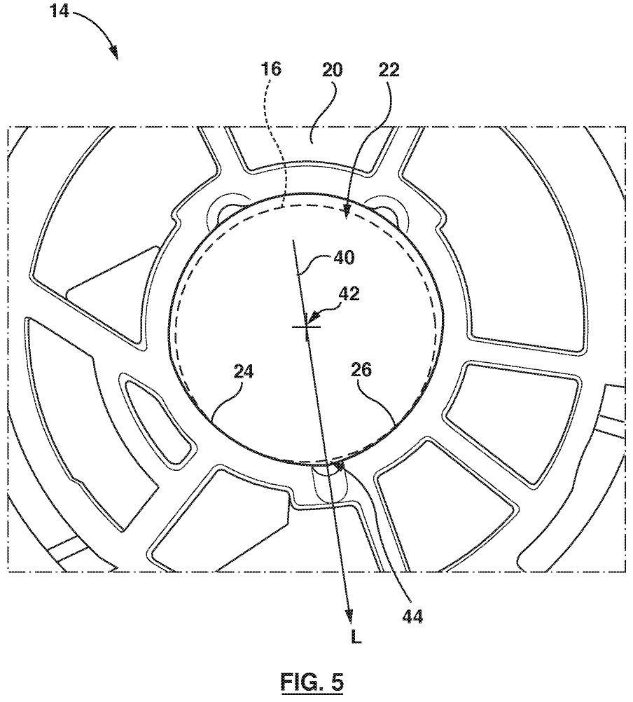

FIG. 5 shows the example bearing 14 as viewed from an end of a shaft 16 that extends through the bearing 14. In this view, the shaft 16 is rendered in hidden line for clarity.

The first and second arcuate support surfaces 24, 26 cradle the shaft 16 against a net radial load L that acts on the shaft 16. The load L may be a vector and hence may have a direction of action that passes through and is perpendicular to the longitudinal axis of the shaft 16. The first and second arcuate support surfaces 24, 26 may be positioned on opposite sides of the direction of action of the net radial load L, so as to cradle the shaft 16 during operation. The support surfaces 24, 26 need not be exclusively on opposite sides of the net radial load L, and a support surface 24, 26 may have a portion the extends to the other side.

The first and second arcuate support surfaces 24, 26 may be symmetrical about a line 40 extending through a center 42 of an opening 22 in the bearing body 20 that accommodates the shaft 16, The opening 22 is non-circular and the center 42 of the opening 22 need not be concentric with the center of the shaft 16. The line 40 of symmetry may be coincident with the direction of action of the net radial load L.

A gap 44 between the bearing body 20 and the shaft 16 may exist where the arcuate support surfaces 24, 26 meet. The gap 44 may be located at or near the effective point of the net radial load L. As may be evident from the meeting of the arcuate support surfaces 24, 26 at the gap 44, the surfaces 24, 26 may resemble a pointed arch.

The arcuate support surfaces 24, 26 may be positioned and shaped to capture the shaft 16 while allowing the shaft to turn in either direction. The arcuate support surfaces 24, 26 may be positioned far enough apart to reduce the chance that the shaft 16 would climb up the surfaces 24, 26 and close enough together to reduce the chance that the shaft 16 becomes wedged between the surfaces 24, 26.

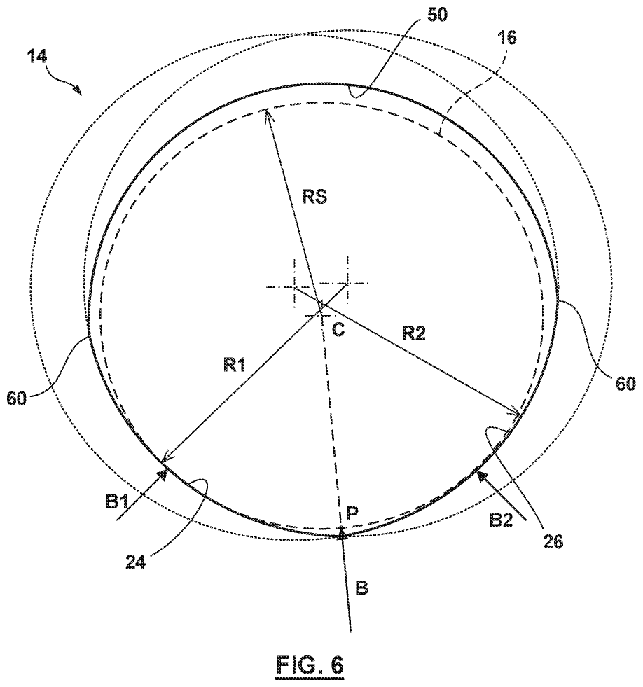

FIG. 6 shows example surfaces of the example bearing 14.

A first arcuate support surface 24 has a radius of curvature R1 that is larger than a radius RS of the shaft 16. A second arcuate support surface 26 has a radius of curvature R2 that is larger than the shaft radius RS. Each radius of curvature R1, R2 may be constant.

The radius of curvature R1, R2 of each support surface 24, 26 may be greater than about 1.1 times the shaft radius RS and smaller than about 1.3 times the radius RS of the shaft 16. For example, each radius R1, R2 may be about 1.2 times the radius RS. The radiuses of curvature R1, R2 of the arcuate support surfaces 24, 26 may be made about equal. The term “about” may mean specified to a dimension or proportion and permitted to differ by a functionally insignificant amount, such as a manufacturing tolerance for the method of manufacture used, such as injection molding, for example.

In the example illustrated, each radius R1, R2 may describe a circle (dotted line) that that is offset from the center C of the shaft 16. The circles described by the radiuses R1, R2 may be non-concentric. Each support surface 24, 26 may have an area of contact around where the respective circle described by the respective radius R1, R2 is tangent to the shaft 16. An extent of an area of contact around the point of tangency may depend on a load applied to the bearing 14 and the materials of the bearing 14 and shaft 16. It is contemplated that the bearing 14 will elastically deform in operation to provide the area of contact.

The centers of the circles described by the radiuses R1, R2 may lie on opposite sides of a line that extends from the center C of the shaft 16 to the point of action P of the net bearing reaction B provided by the support surfaces 24, 26 to support the shaft 16 against its net radial load. The centers of the circles described by the radiuses R1, R2 and the point of action P of the net bearing reaction B provided by the support surfaces 24, 26 may lie on opposite sides of the center C of the shaft 16.

The support surfaces 24, 26 may together span about 180 degrees and may have contact areas separated by about 90 degrees. The 90-degree contact area separation is illustrated by the contributing normal bearing reactions B1, B2 of the support surfaces 24, 26, where the vector sum of the contributing normal bearing reactions, B1+B2, equals the net bearing reaction B. The term “about” may allow for leeway of, for example, +/−10 degrees.

The extents of the support surfaces 24, 26 away from the point of action P of the net bearing reaction B, in other words the extents opposite those that define the gap 44 (FIG. 5), may be connected by a guide surface 50 to completely capture the shaft 16, as shown at 60 in FIG. 6. The guide surface 50 may be a circular surface that may be concentric with the shaft 16 and that may have a larger radius than the shaft 16. The guide surface 50 may be non-concentric with the circles described by the radiuses R1, R2 of the support surfaces 24, 26.

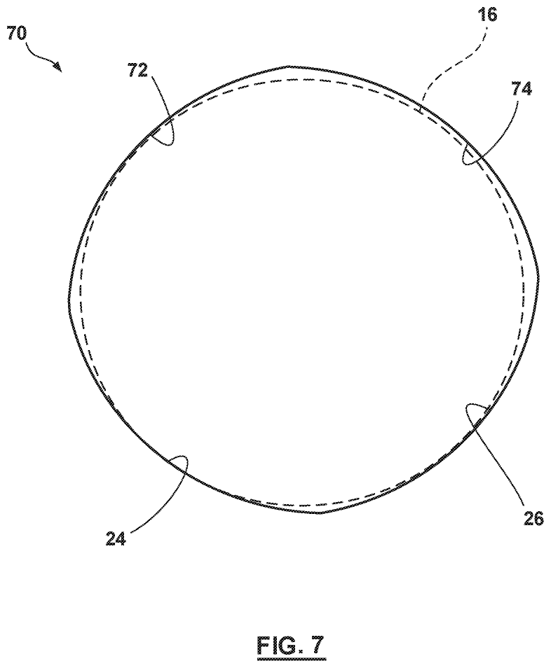

FIG. 7 shows example surfaces of another example bearing 70. The example bearing 70 includes arcuate support surfaces 24, 26, as discussed above, and further includes one or more additional arcuate support surfaces 72, 74. Each arcuate support surface 24, 26 72, 74 may be defined by a radius of curvature that is larger than a radius of a shaft 16 and that is non-concentric with the center of the shaft 16. Features and aspects of the other bearings and machines discussed elsewhere herein may apply to the bearing 70.

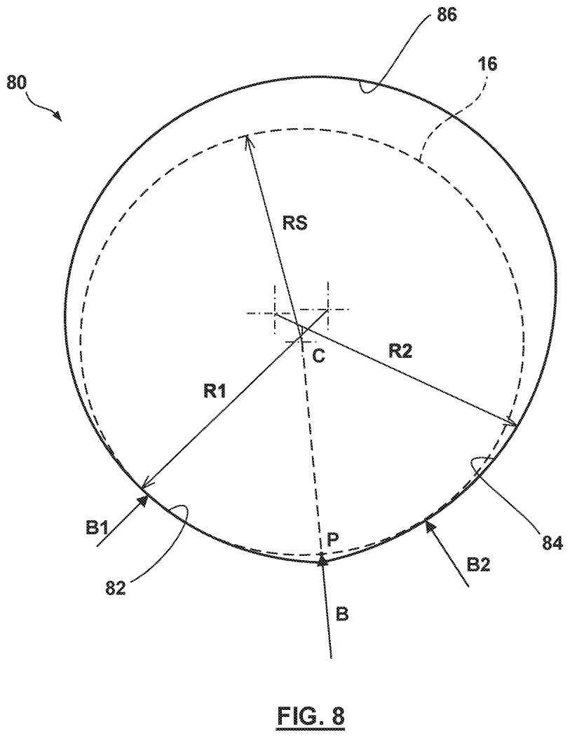

FIG. 8 shows example surfaces of another example bearing 80. The example bearing 80 includes opposing arcuate support surfaces 82, 84 connected by a guide surface 86, The description of the other bearings and surfaces discussed elsewhere herein may be referenced, with like reference numerals denoting like components. The radiuses of curvature R1, R2 of the arcuate support surfaces 82, 84 may be unequal. The degree of difference of the radiuses R1, R2 may be selected for an intended use case of the bearing, an expected net radial load, and other factors.

The bearings described herein may promote wear patterns that reduce the likelihood that the position of a shaft changes undesirably or unpredictably. Such wear patterns may extend the life of the bearing and may allow a machine, such as a printer, that uses the bearing to be used for a longer working life without service. Such a bearing may allow for accurate positioning of a shaft, even after significant wear, to maintain printing quality,

It should be recognized that features and aspects of the various examples provided above can be combined into further examples that also fall within the scope of the present disclosure. In addition, the figures are not to scale and may have size and shape exaggerated for illustrative purposes,

1. A bearing comprising:
a body that defines a first arcuate support surface and a second arcuate support surface, the first and second arcuate support surfaces to cradle a rotatable circular shaft against a net radial load to act on the shaft;
the first arcuate support surface having a radius of curvature larger than a radius of the shaft;
the second arcuate support surface having a radius of curvature larger than the radius of the shaft;
the first and second arcuate support surfaces positioned on opposite sides of a direction of action of the net radial load.

2. The bearing of claim 1, wherein the radius of curvature of the first arcuate support surface and the radius of curvature of the second arcuate support surface are about equal.

3. The bearing of claim 1, wherein the radius of curvature of the first arcuate support surface and the radius of curvature of the second arcuate support surface are unequal.

4. The bearing of claim 1 wherein one or both of the radiuses of curvature of the first arcuate support surface and the second arcuate support surface is greater than about 1.1 times the radius of the shaft and is smaller than about 1.3 times the radius of the shaft.

5. The bearing of claim 1, wherein the firstarcuate support surface and the second arcuate support surface are symmetrical about a line extending through a center of an opening in the body that accommodates the shaft.

6. The bearing of claim 1, wherein first arcuate support surface and the second arcuate support surface meet to provide a gap between the body and the shaft.

7. The bearing of claim 6, wherein extents of the first arcuate support surface and the second arcuate support surface opposite the gap are connected by a guide surface that is non-concentric with the first arcuate support surface and the second arcuate support surface.

8. A printer comprising:
a frame;
a shaft having a radius; and
a bearing fixed to the frame to support the shaft relative to the frame and to allow the shaft to rotate with respect to the frame;
the bearing including a body that defines an opening that receives the shaft, the body defining two opposing arcuate support surfaces to cradle the shaft against a net radial load to act on the shaft, each arcuate support surface having a radius of curvature larger than the radius of the shaft, the arcuate support surfaces positioned on opposite sides of a direction of action of the net radial load.

9. The printer of claim 8, wherein the shaft is a paper-feed shaft.

10. The printer of claim 8, wherein the radiuses of curvature of the arcuate support surfaces are about equal.

11. The printer of claim 8, wherein the radius of curvature is greater than about 1.1 times the radius of the shaft and is smaller than about 1.3 times the radius of the shaft.

12. The printer of claim 8, wherein the arcuate support surfaces are symmetrical about a line extending through a center the shaft.

13. The printer of claim 8, wherein the arcuate support surfaces meet to provide a gap between the body and the shaft.

14. The printer of claim 13, wherein extents of the arcuate support surfaces opposite the gap are connected by a guide surface that is non-concentric with the arcuate support surfaces.

15. The printer of claim 8, wherein the bearing is made of plastic and the shaft is made of metal.
